(19) United States
(12) Patent Application Publication
(10) Pub. No.: US 2024/0086011 A1
(43) Pub. Date: Mar. 14, 2024

(54) METHOD AND APPARATUS FOR DETECTING THE PRESENCE OF A NEFARIOUS SENSOR IN A SURFACE

(71) Applicant: Vestel Elektronik Sanayi ve Ticaret A.S., Manisa (TR)

(72) Inventor: Fatih KURALAY, Manisa (TR)

(21) Appl. No.: 18/275,058

(22) PCT Filed: Feb. 3, 2021
(86) PCT No.: PCT/EP2021/052515

§ 371 Date: Jul. 31, 2023

(51) Int. Cl. G06F 3/041; G06F 3/044

(52) U.S. Cl. CPC G06F 3/0418; G06F 3/044; G06V 40/1306

(57) ABSTRACT

A device (10) is provided for detecting the presence of a nefarious sensor in a surface (100). The device (10) has at least one sensor (20, 22, 24) for detecting the presence of a corresponding sensor in the surface (100). In use, a plurality of sensor values are collected from the at least one sensor (20, 22, 24) of the device (10) as the device (10) is moved across the surface (100). A nefarious sensor can be determined to be present in the surface (100) if the collected sensor values deviate from expected sensor values.

### TECHNICAL FIELD

The present disclosure relates to a method and apparatus for detecting the presence of a nefarious sensor in a surface.

### BACKGROUND

Surfaces that are touched by humans are present in many environments for many different applications and for different purposes. For example, many devices and apparatus are provided in public places, in business premises, etc. to allow people to look up information, enter information for private or business purposes, purchase products and air or train tickets, etc. Such devices and apparatus may for example be or include touchscreens, or may be or include mechanical or opto-mechanical buttons or the like. A problem is that a malicious party may fit a sensor (referred to herein generally as a nefarious sensor) to surfaces, including to such devices and apparatus, in order for example to read fingerprints from users without users or operators of the devices or apparatus being aware. The malicious party may then use the fingerprints for malicious, criminal, etc., purposes.

### SUMMARY

According to a first aspect disclosed herein, there is provided a method of detecting the presence of a nefarious sensor in a surface using a device having at least one sensor for detecting the presence of a corresponding sensor in the surface, the method comprising:
collecting a plurality of sensor values from the at least one sensor of the device as the device is moved across the surface; and
comparing the collected sensor values with expected sensor values which are expected in the case that the surface contains no nefarious sensor;
such that a nefarious sensor can be determined to be present in the surface in the case that the collected sensor values deviate from the expected sensor values.

A user can move the device across the surface, either manually or using for example a motor-driven or similar arrangement. A difference in the sensor values collected by the device from the expected sensor values can be used to indicate that a nefarious sensor is present in the surface. If a nefarious sensor is determined to be present in the surface, appropriate action can be taken.

The surface can in general be any surface. The surface may be the surface of a device or some apparatus. The surface may be the surface of a device or some apparatus which is commonly or frequently touched by people, and may for example be a surface in a public place. Such devices and apparatus may for example be or include touchscreens, or may for example be or include mechanical or opto-mechanical buttons or the like.

In an example, the expected sensor values are zero, and a nefarious sensor is determined to be present in the surface in the case that a collected sensor value has a magnitude greater than zero.

In an example, the expected sensor values are substantially the same across the surface, and a nefarious sensor is determined to be present in the surface in the case that a collected sensor value has a magnitude that is more than a threshold difference from the expected sensor values.

The threshold difference may be for example an absolute amount or a proportional or percentage difference. Either way, a nefarious sensor in the surface can be detected by the presence of a “spike” in the values which are collected by the device. This is based on the fact that in for example a typical touchscreen, the bona fide touch sensors of the touchscreen all tend to cause the at least one sensor of the device to output the same value as the device is moved across the touchscreen, whereas a nefarious sensor will cause a different value to be output as the device is moved across the nefarious sensor. In other cases, where for example the surface is not part of a touchscreen and so is not expected to cause the at least one sensor of the device to output any value, any reading or “spike” from the at least one sensor of the device can be taken to indicate that a nefarious sensor is present.

In an example, the surface is the surface of a touchscreen, the touchscreen having one or more bona fide touch sensors, and comparing the collected sensor values with expected sensor values comprises comparing the collected sensor values with expected sensor values based on the one or more bona fide touch sensors present in the touchscreen, wherein the expected sensor values are derived from stored data that corresponds to one or more bona fide touch sensors present in the touchscreen.

In this example, data that corresponds to one or more bona fide touch sensors present in the touchscreen may be obtained from for example the manufacturer of the touchscreen and pre-stored for use in the comparison. This enables a more accurate and reliable determination to be made of whether a nefarious sensor is present in the touchscreen.

In an example, the method comprises recording location data for the location of the device relative to the surface for each location where a sensor value is collected.

Such location data can be used when the collected sensor values are compared with the expected sensor values and/or to identify the location of a nefarious sensor in the surface.

In an example, the at least one sensor of the device is one of a capacitive sensor, an optical sensor and an audio sensor for detecting the presence of a corresponding capacitive, optical or audio fingerprint sensor respectively in the surface.

In an example, the device comprises a capacitive sensor, an optical sensor and an audio sensor for detecting the presence of a capacitive sensor, an optical sensor and an audio fingerprint sensor respectively in the surface.

According to a second aspect disclosed herein, there is provided apparatus for detecting the presence of a nefarious sensor in a surface, the apparatus comprising:
a device having at least one sensor for detecting the presence of a corresponding sensor in the surface; and
a processing system for receiving a plurality of sensor values from the at least one sensor of the device as the device is moved across the surface;
the processing system being configured to compare the collected sensor values with expected sensor values which are expected in the case that the surface contains no nefarious sensor;
such that a nefarious sensor can be determined to be present in the surface in the case that the collected sensor values deviate from the expected sensor values.

In an example, the processing system is configured to determine that a nefarious sensor is present in the surface in the case that a collected sensor value has a magnitude that is more than a threshold difference from the expected sensor values.

In an example, the apparatus has data storage for storing data corresponding to one or more bona fide touch sensors present in a touchscreen, the processing system being configured to determine that a nefarious sensor is present in the touchscreen by comparing the collected sensor values, which are collected as the device is moved across the surface of a said touchscreen, with expected sensor values which are derived from the stored data corresponding to the one or more bona fide touch sensors present in the touchscreen.

In an example, the at least one sensor of the device is one of a capacitive sensor, an optical sensor and an audio sensor for detecting the presence of a corresponding capacitive, optical or audio fingerprint sensor respectively in a said surface.

In an example, the device comprises a capacitive sensor, an optical sensor and an audio sensor for detecting the presence of a capacitive sensor, an optical sensor and an audio fingerprint sensor respectively in a said surface.

### BRIEF DESCRIPTION OF THE DRAWINGS

To assist understanding of the present disclosure and to show how embodiments may be put into effect, reference is made by way of example to the accompanying drawings in which:

FIGS. 1 and 2 show schematically a perspective view from one side and a perspective view from below of an example of a device for detecting the presence of a nefarious sensor in a surface according to the present disclosure;

FIG. 3 shows schematically the device of FIGS. 1 and 2 being moved across a surface;

FIGS. 4 and 5 show schematically examples of capacitive fingerprint sensors;

FIGS. 6 and 7 show schematically examples of capacitive sensors in the device of FIGS. 1 and 2 for detecting the presence of capacitive fingerprint sensors according to FIGS. 4 and 5 respectively;

FIG. 8 shows schematically an example of an optical fingerprint sensor and optical sensors in the device of FIGS. 1 and 2 for detecting the presence of an optical fingerprint sensor;

FIG. 9 shows schematically an example of an audio fingerprint sensor and audio sensors in the device of FIGS. 1 and 2 for detecting the presence of an audio fingerprint sensor; and

FIGS. 10 to 12 show schematically examples of readings obtained from the device of FIGS. 1 and 2.

### DETAILED DESCRIPTION

As noted, surfaces that are touched by humans are present or used in many environments for many different applications and for different purposes. For example, many devices and apparatus are provided in public places, such as shopping centres, airports, railway stations, libraries, etc., in busines premises, etc. to allow people to look up information, enter information for private or business purposes, purchase products and air or train tickets, etc. Such devices and apparatus may for example be or include touchscreens. Alternatively or additionally, such devices and apparatus may for example include mechanical or opto-mechanical buttons or the like. A problem is that a malicious party may fit a sensor (referred to herein generally as a nefarious sensor) to any surface in order for example to read fingerprints without people being aware. For example, it is known that malicious parties do fit fingerprint scanners or readers to touchscreens and other (non-touchscreen) devices and apparatus to read people's fingerprints without their knowledge. The malicious party may then use the fingerprints for malicious, criminal, etc., purposes.

Examples described herein provide a device that has at least one sensor for detecting the presence of a corresponding sensor in a surface. A plurality of sensor values are collected from the at least one sensor of the device as the device is moved across the surface. The collected sensor values are compared with expected sensor values which are expected in the case that the surface contains no nefarious sensor. A nefarious sensor can be determined to be present in the surface in the case that the collected sensor values deviate from the expected sensor values.

The device can be used to certify that the surface contains no nefarious sensors. This may be carried out as a “one off” process, when for example a device or apparatus that includes the surface is first installed at a location. Alternatively, the process may be carried out from time to time, for example once a day, by sweeping the device over any devices or apparatus at a location to check that no nefarious sensor has been fitted by a malicious person. If a nefarious sensor is determined to be present, appropriate action can be taken, such as for example shutting down or deactivating the device or apparatus, at least until the nefarious sensor is removed.

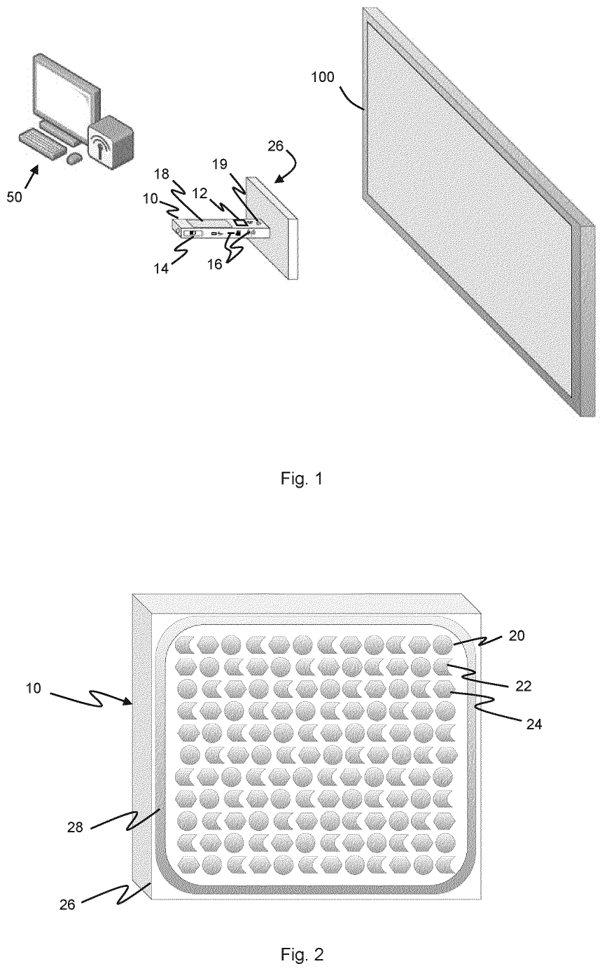

Referring to FIGS. 1 and 2, these show schematically a perspective view from one side and a perspective view from below of an example of a device 10 for detecting the presence of a nefarious sensor in a surface 100 according to the present disclosure. The device 10 may be relatively small, for example a few centimetres in each dimension, such as for example having a base of 3 cm×3 cm or so. The device 10 may be smaller than the surface 100 being tested or alternatively the same size as or larger than the surface being tested. The device 10 in the example shown has a processor, working memory and data storage, all indicated schematically by a block 12. The device 10 of this example is battery-powered, having an internal (rechargeable) battery 14, but alternatively or additionally may be mains-powered.

The device 10 may be entirely self-contained, and carries out the desired processing of readings. Alternatively or additionally, the device 10 may be part of an apparatus that has a separate processor, memory and data storage. For example, the device 10 may be connected via a wired or wireless connection 16 to a separate computer 50 which receives readings from the device 10 and carries out the desired processing. The device 10 may have a display screen 18 and/or an audio output device 19 for outputting visual or audio warnings or the like, which may for example be output if a nefarious sensor is detected in a surface 100 which is being scanned.

The device 10 has at least one sensor for detecting the presence of a corresponding sensor in a surface 100. The device 10 may have two or more (such as three) different types of sensor for detecting the presence of two more corresponding different types of sensor in a surface 100. In this regard, as will be discussed, fingerprint sensors are commonly capacitive, optical or audio. Accordingly, in this example, the device 10 has capacitive, optical and audio sensors so as to be able to detect the presence of a nefarious sensor that uses any of these technology types.

Referring particularly to FIG. 2, in this specific example, the device 10 is shown having plural capacitive sensors 20, plural optical sensors 22, and plural audio sensors 24. Each of the sensors 20, 22, 24 is located on or close to a lower surface 26 of the device 10, which in use is presented to and preferably placed in contact with the surface 100 that is being scanned. A strip or gasket 28 is located on the surface 26 to surround the sensors 20, 22, 24. The strip 28 may be mounted or located in a circumferential groove in the surface 26. The strip 28 assists in isolating the sensors 20, 22, 24 from sound and light in the environment and can prevent scratching of the surface 100 of device or apparatus, etc. being tested. The strip 28 may be formed of for example a natural or synthetic elastomer, rubber, plastics, etc.

The different types of sensors 20, 22, 24 are shown alternating with each other and each arranged in a regular array. Other arrangements are possible. For example, there may be plural sensors of one type, but only a single sensor of the or each other type. As another example, the different types of sensors any be arranged irregularly, with for example a first set of one type of sensor, followed by a second set of a second type of sensor, and a third set of a third type of sensor. Such different arrangements may be convenient in terms of making wired connections between the sensors 20, 22, 24 and the processor 12 or output of the device 10.

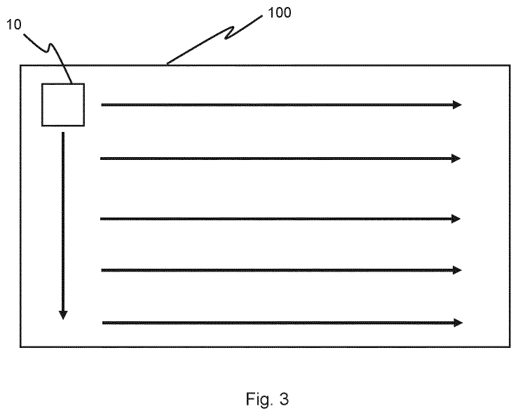

FIG. 3 shows schematically the device 10 of FIGS. 1 and 2 being moved across a surface 100. As indicated schematically, the device 10 is moved from side to side of the surface 100. The device 10 is then moved down and moved side to side again. This is repeated until the device 10 has been swept across the whole surface 100.

The device 10 may be moved manually by a user. Alternatively, there may be for example a motor arrangement or the like (not shown) which moves the device 10 across the surface 100. Location data, such as X-Y coordinate data, corresponding to the location of the device 10 relative to the surface 100 may be recorded as the device is moved across the surface 100. Such location data can be used when the collected sensor values are compared with the expected sensor values and/or to identify the location of a nefarious sensor in the surface, as will be described further below. The location data may be stored automatically, for example as the device 10 is driven across the surface 100 by a motor arrangement or the like, or may be entered manually by a user as the user moves the device 10 manually. The location data may be stored and used locally at the device 10 and/or transmitted to a separate computer or the like.

As mentioned and as is known per se, a number of different types of touch sensors, including in particular fingerprint sensors or “readers”, are known.

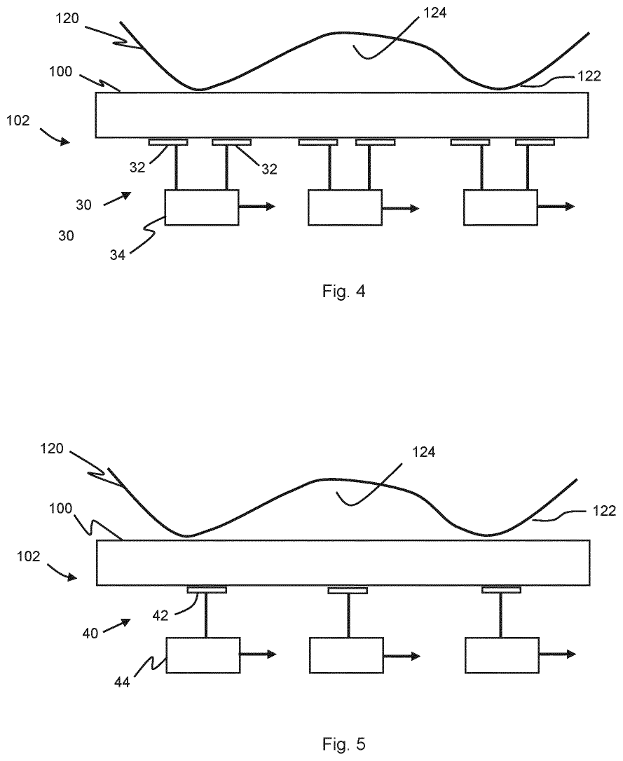

FIGS. 4 and 5 show schematically examples of capacitive fingerprint sensors 30, which may be present in a surface 100. Such capacitive fingerprint sensors 30 may be bona fide sensors which are provided legitimately as part of a touchscreen 102, but also may be fitted for nefarious purposes by third parties. The example of FIG. 4 has two conductive plates 32 per capacitive fingerprint sensor 30 whereas the example of FIG. 5 has a single conductive plate 42 per capacitive fingerprint sensor 40. The conductive plates 32, 42 are located below or embedded in the surface 100, which is typically electrically insulating and may be glass, plastics, etc. In either case, the or each conductive plate 32, 42 is connected to an integrator circuit 34, 44, which typically includes an inverting operational amplifier with an inverting terminal and a non-inverting terminal connected to ground and which provides an output which is a measure of capacitance. FIGS. 4 and 5 show the lower part of a finger 120, which has ridges 122 and valleys 124 that make up the fingerprint of the finger 120.

In the example of FIG. 4 which has two conductive plates 32 per capacitive fingerprint sensor 30, a capacitor is formed between the two plates 32. Further, when a finger 120 is brought close to the conductive plates 32, the surface of the finger 120 forms a third capacitor plate. Depending on whether a ridge 122 or a valley 124 is close to the plates 32, a different value for the capacitance is obtained for the capacitor formed by the plates 32. Similarly, for the example of FIG. 5 which has a single conductive plate 42 per capacitive fingerprint sensor 40, the surface of the finger 120 acts as a second capacitor plate to form a capacitor with the conductive plate 42. Again, depending on whether a ridge 122 or a valley 124 is close to the plate 42, a different value for the capacitance is obtained for the capacitor formed by the plate 42 and the finger 120.

In either case, the different values of capacitance that are measured depending on whether a ridge 122 or a valley 124 is close to the sensor 30, 40 are used to “read” the user's fingerprint, i.e. to obtain an image or other representation of the fingerprint in a manner known per se.

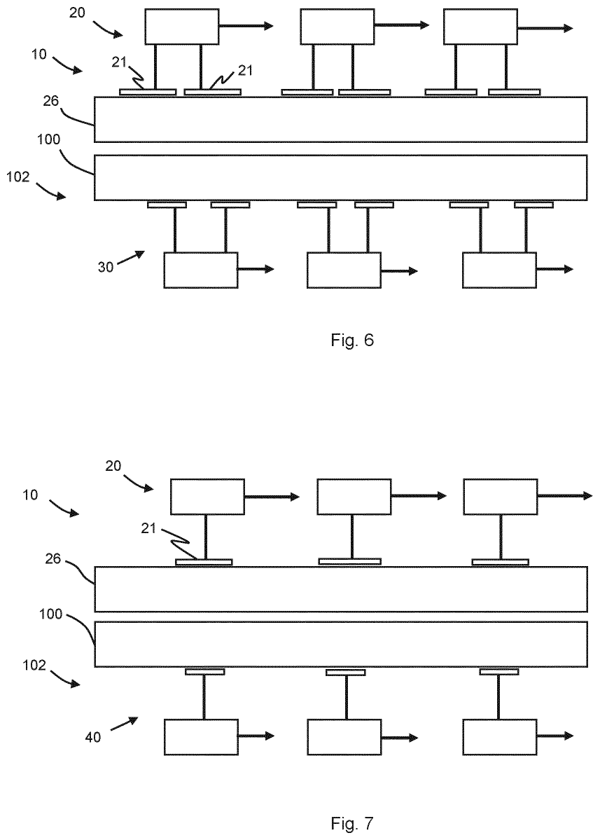

In order to be able to detect the presence of a capacitive sensor of the type shown in FIG. 4 or FIG. 5, the device 10 may be provided with a corresponding capacitive sensor, as shown schematically in FIGS. 6 and 7 respectively. The example device 10 of FIG. 6 has plural capacitive sensors 20 that are of the type having two conductive plates 21, whereas the example device 10 of FIG. 7 has plural capacitive sensors 20 that are of the type having a single conductive plate 21. In other examples, the device 10 may have capacitive sensors 20 of both types. In any case, the conductive plates 21 are located below or embedded in the lower surface 26 of the device 10, which is typically electrically insulating and may be glass, plastics, etc. In either case, the capacitive sensors 20 of the device 10 operate similarly to the sensors 30, 40 described above. In particular, the capacitive sensors 20 of the device output different values of measured capacitance (typically a high value of capacitance) when located over a sensor 30, 40 compared to when the capacitive sensors 20 of the device 10 are not located over a sensor 30, 40. This difference in output value can be used to identify that a sensor 30, 40 is present and, as will be discussed, this can be taken to be an indication that a nefarious capacitive sensor is present in the surface 100.

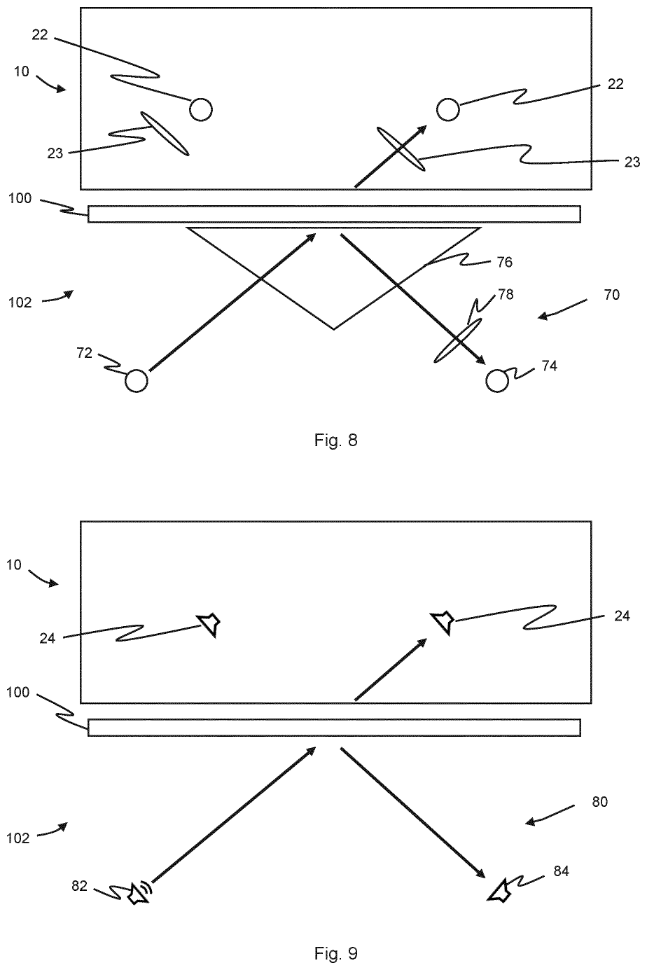

As mentioned, other types of sensor that are used for reading fingerprints use optical technology or audio technology. FIG. 8 shows schematically an example of an optical fingerprint sensor 70 of a surface 100 and optical sensors 22 in the device 10 of FIGS. 1 and 2 for detecting the presence of an optical fingerprint sensor 70. FIG. 9 shows schematically an example of an audio fingerprint sensor 80 of a surface 100 and audio sensors 24 in the device 10 of FIGS. 1 and 2 for detecting the presence of an audio fingerprint sensor 80.

Referring to FIG. 8, an optical fingerprint sensor 70 has a light source 72 for emitting light towards the surface 100 and a light detector 74 for detecting light reflected by an object that is above the surface 100. The light source 72 may be for example an LED and the light detector 74 may be for example a photodiode, a CCD (charge-coupled device), etc., and may respectively emit and detect infrared light or light of some other wavelength. A prism 76 may be located under the surface 100 between the light source 72 and the light detector 74 and a lens 78 may be provided in front of the light detector 74 to assist in directing and focusing the light. When used as a fingerprint sensor, different amounts of light are reflected back to the light detector 74 depending on whether a ridge or a valley of a fingerprint is reflecting the light. This is used to build up an image of the fingerprint in a manner known per se.

To detect the presence of an optical fingerprint sensor 70, the device 10 has one or more optical sensors 22 for detecting light transmitted by a light source 72 of an optical fingerprint sensor 70. Again, the optical sensors 22 may be for example photodiodes, CCDs, etc., which preferably have a wide spectrum (because the wavelength used by a nefarious light source 72 is unknown) A lens 23 may be positioned in front of each optical sensor 22 to focus the light onto the optical sensor 22. The optical sensors 22 will detect light that is emitted by a light source 72 of an optical fingerprint sensor 70 located in the surface 100 as the device 10 is moved across the surface 100, indicating the present of an optical fingerprint sensor 70 in the surface 100. As will be discussed, this can be taken to be an indication that a nefarious optical sensor is present in the surface 100.

Referring to FIG. 9, an audio fingerprint sensor 80 has a sound source 82 for emitting sound towards the surface 100 and a sound detector 84 for detecting sound reflected by an object that is above the surface 100. The sound source 82 may emit for example ultrasound (above for example 20 kHz) and the sound detector 84 may correspondingly detect ultrasound, though other wavelengths may be used. When used as a fingerprint sensor, different amounts of sound are reflected back to the sound detector 84 depending on whether a ridge or a valley of a fingerprint is reflecting the sound, and this is used to build up an image of the fingerprint in a manner known per se.

To detect the presence of an audio fingerprint sensor 80, the device 10 has one or more sound sensors 24 for detecting sound transmitted by a sound source 82 of an audio fingerprint sensor 80. The sound sensors 24 will detect sound that is emitted by a sound source 82 of an audio fingerprint sensor 80 located in the surface 100 as the device 10 is moved across the surface 100, indicating the present of an audio fingerprint sensor 80 in the surface 100. As will be discussed, this can be taken to be an indication that a nefarious audio sensor is present in the surface 100.

As noted, the device 10 may have only one type of sensor, for example capacitive or optical or audio, for detecting a corresponding type of nefarious sensor in a surface 100. However, in general, a nefarious sensor may be of any type, which is of course unknown at the time the surface 100 is being scanned. The most common types, currently at least, of fingerprint sensor are capacitive and optical, and the device 10 may therefore have at least capacitive and optical sensors. Nevertheless, the device 10 most preferably has capacitive, optical and audio sensors so as to be able to detect the broadest range of types of nefarious sensor which may be present.

As noted, in use, the device 10 is moved across a surface 100 which is being scanned for the presence of a nefarious sensor. Sensor values from the or each sensor 20, 22, 24 in the device 10 are collected as the device 10 is moved. Those sensor values are compared with expected sensor values which are expected in the case that the surface 100 contains no nefarious sensor. The comparison may be made locally at the device 10 or the sensor values may be transmitted to an external computer 50 for processing. The presence of a nefarious sensor in the surface 100 may be indicated if the collected sensor values differ or deviate from the expected values, which are values that are expected if the surface 100 does not have a nefarious sensor.

For example, the processing of the collected sensor values may be such that a nefarious sensor is determined to be present in the surface 100 if a collected sensor value has a magnitude that is more than a threshold difference from the expected sensor values. This threshold difference may be for example an absolute amount or a proportional or percentage difference. Either way, a nefarious sensor in the surface 100 can be detected by the presence of a “spike” in the values collected by the device to be generated.

In the case that the surface 100 is the surface 100 of a device or apparatus that is not expected to have any touch or fingerprint sensor or the like, or even just some general surface that is not part of some device or apparatus (such as the surface of a table, other furniture, handrail, etc.), then the expected sensor values that are collected by the device 10 as the device 10 is moved over the surface 100 are zero (or at least very close to zero, given that noise may cause low values to be generated in any event). In that case, in essence any sensor value above zero can be taken to indicate that a nefarious sensor is present in the surface 100.

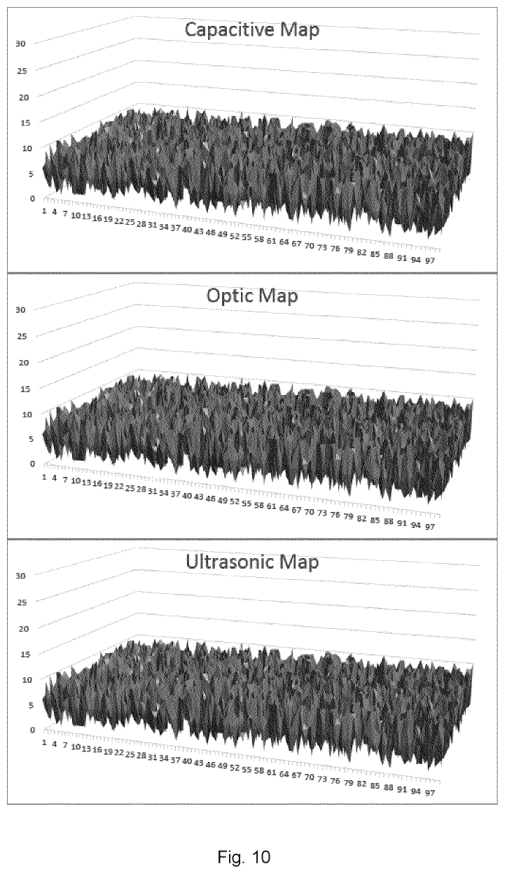

On the other hand, in the case that the surface 100 is the surface 100 of a touchscreen 102 or the like, the surface 100 will contain one or more bona fide sensors. Such bona fide sensors will in general cause the sensor(s) 20, 22, 24 of the device 10 to output values as the device 10 is moved over the surface 100. This is illustrated by way of example in FIGS. 10 to 12, which show schematically examples of readings obtained from the device 10 as it is scanned across a touchscreen 102 or the like that contains one or more bona fide sensors.

Referring first to FIG. 10, this shows schematically from top to bottom examples of “maps” of sensor readings for capacitive, optical and audio sensors 20, 22, 24 respectively. In this example, there is no nefarious sensor in the touchscreen 102. As a result, the maps are relatively uniform or homogeneous, in that all outputs from the respective capacitive, optical and audio sensors 20, 22, 24 of the device 10 are all of approximately the same value. In this regard, it is noted that this may be because the touchscreen 102 or the like uses for example bona fide sensors of one or two types (for example, capacitive and optical) and these are uniformly distributed across the touchscreen, and no sensors of any other type (for example audio), such that, either way, the outputs from the respective capacitive, optical and audio sensors 20, 22, 24 of the device 10 are all of approximately the same value (i.e. each map is generally flat, even though the values that are output for the three maps will typically be different as they represent different things, namely capacitance, light intensity and audio volume respectively).

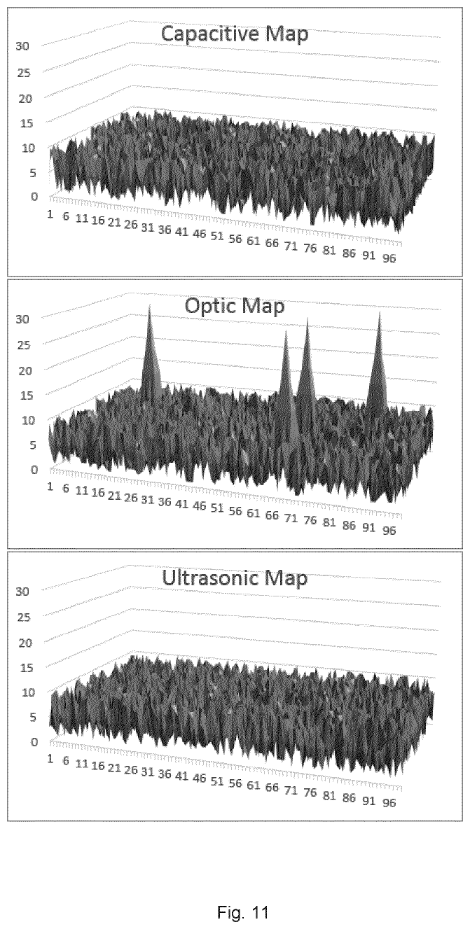

On the other hand, referring to FIG. 11, this again shows schematically from top to bottom examples of maps of sensor readings for capacitive, optical and audio sensors 20, 22, 24 respectively. In this case, the touchscreen 102 or the like has four optical sensors, which are at different locations, as indicated by the four large spikes in the map produced by the optical sensors 22 of the device 10. Given the high values of these spikes, it is determined that there are four optical sensors present in the touchscreen 102 are nefarious. The maps for the capacitive sensors 20 and the audio sensors 24 are flat, so it is determined that there are no nefarious capacitive or audio sensors in the touchscreen 102.

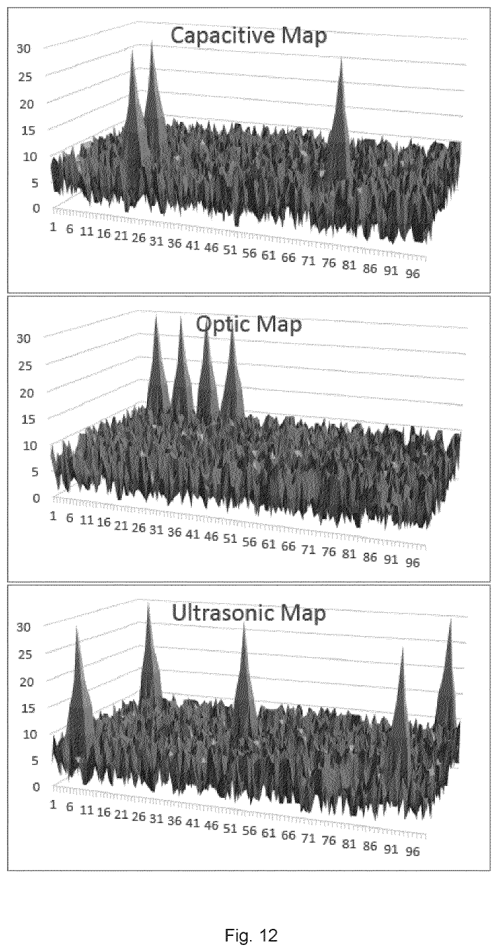

Referring as an other example to FIG. 12, this again shows schematically from top to bottom examples of maps of sensor readings for capacitive, optical and audio sensors 20, 22, 24 respectively. In this case, each of the capacitive, optical and audio maps has spikes in the values, such that it is determined that there are nefarious sensors of each type. Specifically, in the example shown, the device 10 has found three nefarious capacitive sensors, four nefarious optical sensors and five nefarious audio sensors.

This use of the device 10 and looking for spikes in the maps of the sensor readings may be sufficient to provide a reliable identification of the presence of a nefarious sensor in the surface 100. However, the reliability and accuracy of the identification can be improved by taking into account the structure and arrangement of the particular surface 100 which is being scanned. For example, any bona fide sensors of a touchscreen 102 may not be uniformly distributed across the surface 100 so spikes in the output of the sensors 20, 22, 24 may be expected in any event, even if no nefarious sensor is present. In an example, therefore, data concerning the location of any bona fide sensors in the touchscreen 102 or other device or apparatus being scanned may be stored, either locally at the device 10 if the comparison is made locally or at the external computer 50 if the comparison is made at an external computer 50. This allows the location of any bona fide sensors to be taken into account, such that spikes in the outputs of the sensors 20, 22, 24 of the device 10 at those locations may be ignored on the basis that they were expected. Similarly, there may be other components or circuitry in the touchscreen 102 or other device or apparatus being scanned may that may cause spikes in the readings of one or more of capacitive, optical and audio sensors. Data concerning the location of such other components or circuitry may also be stored and readings at those locations ignored for the purpose of determining whether a nefarious sensor is present. Such data concerning the location of bona fide sensors and any other components or circuitry may be provided by for example the manufacturer of the touchscreen 102 or other device or apparatus.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Reference is made herein to data storage for storing data. This may be provided by a single device or by plural devices. Suitable devices include for example a hard disk and non-volatile semiconductor memory (including for example a solid-state drive or SSD).

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The examples described herein are to be understood as illustrative examples of embodiments of the invention. Further embodiments and examples are envisaged.

Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A method of detecting the presence of a nefarious sensor in a surface using a device having at least one sensor for detecting the presence of a corresponding sensor in the surface, the method comprising:
collecting a plurality of sensor values from the at least one sensor of the device as the device is moved across the surface; and
comparing the collected sensor values with expected sensor values which are expected in the case that the surface contains no nefarious sensor;
such that a nefarious sensor can be determined to be present in the surface in the case that the collected sensor values deviate from the expected sensor values.

2. A method according to claim 1, wherein the expected sensor values are zero, and a nefarious sensor is determined to be present in the surface in the case that a collected sensor value has a magnitude greater than zero.

3. A method according to claim 1, wherein the expected sensor values are substantially the same across the surface, and a nefarious sensor is determined to be present in the surface in the case that a collected sensor value has a magnitude that is more than a threshold difference from the expected sensor values.

4. A method according to claim 1, wherein the surface is the surface of a touchscreen, the touchscreen having one or more bona fide touch sensors, wherein comparing the collected sensor values with expected sensor values comprises comparing the collected sensor values with expected sensor values based on the one or more bona fide touch sensors present in the touchscreen, wherein the expected sensor values are derived from stored data that corresponds to one or more bona fide touch sensors present in the touchscreen.

5. A method according to claim 4, comprising recording location data for the location of the device relative to the surface for each location where a sensor value is collected.

6. A method according to claim 1, wherein the at least one sensor of the device is one of a capacitive sensor, an optical sensor and an audio sensor for detecting the presence of a corresponding capacitive, optical or audio fingerprint sensor respectively in the surface.

7. A method according to claim 1, wherein the device comprises a capacitive sensor, an optical sensor and an audio sensor for detecting the presence of a capacitive sensor, an optical sensor and an audio fingerprint sensor respectively in the surface.

8. Apparatus for detecting the presence of a nefarious sensor in a surface, the apparatus comprising:
a device having at least one sensor for detecting the presence of a corresponding sensor in the surface; and
a processing system for receiving a plurality of sensor values from the at least one sensor of the device as the device is moved across the surface;
the processing system being configured to compare the collected sensor values with expected sensor values which are expected in the case that the surface contains no nefarious sensor;
such that a nefarious sensor can be determined to be present in the surface in the case that the collected sensor values deviate from the expected sensor values.

9. Apparatus according to claim 8, wherein the processing system is configured to determine that a nefarious sensor is present in the surface in the case that a collected sensor value has a magnitude that is more than a threshold difference from the expected sensor values.

10. Apparatus according to claim 8, the apparatus having data storage for storing data corresponding to one or more bona fide touch sensors present in a touchscreen, the processing system being configured to determine that a nefarious sensor is present in the touchscreen by comparing the collected sensor values, which are collected as the device is moved across the surface of a said touchscreen, with expected sensor values which are derived from the stored data corresponding to the one or more bona fide touch sensors present in the touchscreen.

11. Apparatus according to claim 8, wherein the at least one sensor of the device is one of a capacitive sensor, an optical sensor and an audio sensor for detecting the presence of a corresponding capacitive, optical or audio fingerprint sensor respectively in a said surface.

12. Apparatus according to claim 8, wherein the device comprises a capacitive sensor, an optical sensor and an audio sensor for detecting the presence of a capacitive sensor, an optical sensor and an audio fingerprint sensor respectively in a said surface.
